(19) United States
(12) Patent Application Publication
(10) Pub. No.: US 2009/0039073 A1
(43) Pub. Date: Feb. 12, 2009

(54) METHODS AND DEVICES FOR CONTROLLING TEMPERATURE WITHOUT TEMPERATURE SENSOR

(75) Inventors: Min Guo, Beijing (CN); Keyue Shen, Beijing (CN); Cheng Zhou, Beijing (CN); Xiaosheng Guan, Beijing (CN); Jing Cheng, Beijing (CN)

Correspondence Address: MORRISON & FOERSTER LLP, 755 PAGE MILL RD, PALO ALTO, CA, 94304-1018, US

(73) Assignee: CapitalBio Corporation

(21) Appl. No.: 12/088,422

(22) PCT Filed: Dec. 22, 2006
(86) PCT No.: PCT/CN2006/003542

§ 371 Date: Jul. 21, 2008

(30) Foreign Application Priority Data
Dec. 31, 2005 (CN) 200510135478.6

(51) Int. Cl. H05B 1/02; G05D 23/00; H05B 3/40

(52) U.S. Cl. 219/494; 700/299; 219/552

(57) ABSTRACT

Methods and devices for controlling temperature by precise heating without the need of using a temperature sensor are provided. The device comprises a resistive heating element (6), a controller (3), a heating circuit and a temperature sensing circuit. The temperature of the resistive heating element can be determined based on the resistance of the resistive heating element (6), which changes monotonically with its temperature. The resistive heating element (6) thus serves both as a heating element and as a temperature sensor, thereby obviating the need for a separate temperature sensor.

### TECHNICAL FIELD

This application pertains to methods and devices for temperature control without the se of a temperature sensor.

### BACKGROUND

Temperature control is commonly used in the biological, chemical, pharmaceutical, electronic appliances, and other fields. Traditional temperature control devices for precise control of temperature such as thermistor, thermocouple, simulated silicon temperature sensor, nickel/platinum resistance temperature detectors use a temperature sensor to measure the temperature of the heated parts and a closed-loop circuit to control the temperature. When the parts to be temperature-controlled cannot be accessed by a temperature sensor due to restrictions such as size, distance, and electric field, the closed-loop heating control cannot be performed, and consequently precision of the temperature control system will be compromised. An improved temperature control device does not use a temperature sensor, but rather uses the bridge measurement method to directly measure changes of the resistance of a resistive heating element, thereby providing an onsite temperature feedback control. Bridge measurement methods typically need three additional matching resistors, which significantly complicates the system. In addition, the controller and the heating elements are often located at quite a distance from each other so that a connector is necessary to link the controller and the heating elements. The matching resistors are generally positioned close to the controller, away from the heating elements. The uncertainty of contact resistance caused by the connector, as well as the distributed resistance of the wires, will affect the result of the resistance measurement by using the bridge measurement method. Accordingly, these temperature measurement devices cannot achieve high precision and reproducibility.

The disclosures of all publications, patents, patent applications and published patent applications referred to herein are hereby incorporated herein by reference in their entirety.

### BRIEF SUMMARY OF THE INVENTION

The present invention provides methods and devices for precise temperature control. In some embodiments, there is provided a temperature control device comprising (and in some embodiments consisting of or consisting essentially of): a resistive heating element, a temperature sensing circuit, a heating circuit, and a controller, wherein the resistance of the resistive heating element monotonically changes with its temperature, wherein the temperature sensing circuit is configured to determine the temperature of the resistive heating element, wherein the heating circuit is configured to heat the resistive heating element, and wherein the controller is configured to control the activation of the temperature sensing circuit and the heating circuit. In some embodiments, the resistive heating element is connected with four wires arranged sequentially, wherein the two distal wires are connected to the heating circuit, wherein the two middle wires are connected to the temperature sensing circuit, and wherein the connection points of the two middle wires on the resistive heating element are substantially far from each other.

In some embodiments, there is provided a temperature control device comprising (and in some embodiments consisting of or consisting essentially of): a) a resistive heating element, wherein the resistance of the resistive heating element monotonically changes with its temperature, b) a temperature sensing circuit configured to determine the temperature of the resistive heating element, comprising a first electric switch, a precision constant current source, a voltage differential amplifier, and an analog/digital converter, c) a heating circuit configured to heat the resistive heating element, comprising a second electric switch and a constant voltage source, and d) a controller configured to control the activation of the temperature sensing circuit and the heating circuit, wherein the output end of the amplifier is connected to the input end of the analog/digital converter, wherein the output end of the analog/digital converter is connected to the input end of the controller. In some embodiments, the resistive heating element is connected with four wires arranged sequentially, wherein the two distal wires are connected to the heating circuit, wherein the two middle wires are connected to the temperature sensing circuit, and wherein the connection points of the two middle wires on the resistive heating element are substantially far from each other.

In another aspect, there is provided a method of controlling temperature of a resistive heating element wherein the resistance of the resistive heating element monotonically changes with its temperature, comprising: a) sensing an initial temperature of the resistive heating element, b) passing electric current through the resistive heating element for a predetermined heating period to increase the temperature of the resistive heating element when the initial temperature of the heating element is below a predetermined target temperature, c) repeating steps a) and b). In some embodiments, the step of sensing the temperature of the resistive heating element is achieved by determining the resistance of the resistive heating element (for example by four-terminal measurement methods described herein).

Also provided herein are uses of the methods and devices for controlling temperatures in various contexts, such as controlling temperature of liquids in capillary tubes.

### BRIEF DESCRIPTION OF THE FIGURES

FIG. 1 provides a schematic diagram of an exemplary temperature control device of the present invention.

FIG. 2 provides exemplary electric current curve and temperature curves for the temperature control device. The upper curve represents the current on the resistive heating element. The lower curve represents the actual temperature of the resistive heating element.

### DETAILED DESCRIPTION OF THE INVENTION

The present invention in one aspect provides a simple, low cost, and high precision temperature control device. Specifically, the invention provides a temperature control device comprising (and in some embodiments consisting of or consisting essentially of) a resistive heating element, a controller, a heating circuit, and a temperature sensing circuit. The temperature of the resistive heating element can be determined based on the resistance of the resistive heating element, which changes monotonically with its temperature. The resistive heating element thus serves both as a heating element and as a temperature sensor, thereby obviating the need for a separate temperature sensor.

In the device of the present invention, both the heating circuit and the temperature sensing circuit are connected to the resistive heating element. The heating circuit is configured to heat the resistive heating element. The temperature sensing circuit is configured to sense the temperature of the resistive heating element. The controller controls the activation of the heating circuit and the temperature sensing circuit. For example, the controller periodically turns on the temperature sensing circuit to determine the temperature of the resistive heating element. When temperature of the resistive heating element falls below a target temperature, the controller turns on the heating circuit for a predetermined period of time, which increases the temperature of the resistive heating element. Once the heating circuit is turned off, the resistive heating element is allowed to cool down naturally.

The invention thus provides a temperature control device comprising (and in some embodiments consisting of or consisting essentially of) a resistive heating element, a temperature sensing circuit, a heating circuit, and a controller, wherein the resistance of the resistive heating element monotonically changes with its temperature, wherein the temperature sensing circuit is configured to determine the temperature of the resistive heating element, wherein the heating circuit is configured to heat the resistive heating element, and wherein the controller is configured to control the activation of the temperature sensing circuit and the heating circuit. In some embodiments, the temperature device does not comprise a separate temperature sensor (i.e., a temperature sensor other than the resistive heating element).

Materials suitable for the resistive heating element include, for example, copper, aluminum, aurum, argent, and alloy. The resistive heating element can be of any shape that is compatible with parts to be heated. For example, in some embodiments when the part to be heated is a tube (such as a capillary tube), the resistive heating element can be in the shape of wires winding around the outer surface of the capillary tube. Alternatively, the resistive heating element can be wires aligned at the outer surface of the capillary tube. In some embodiments, the resistive heating element can be in the shape of a sheet wrapping around the capillary tube.

The controller receives information from the temperature sensing circuit and controls activation of the heating circuit and the temperature sensing circuit. When the heating circuit is turned on and the temperature sensing circuit is turned off, the device is in a heating mode, and the resistive heating element is heated. When both the heating circuit and the temperature sensing circuit are turned off, the device is in a resting mode. When the temperature sensing circuit is turned on and the heating circuit is turned off, the device is in a temperature sensing mode, and the temperature of the resistive heating element is determined. The controller compares temperature of the resistive heating element with a target temperature. When the temperature of the resistive heating element is higher than or equals to the target temperature, the controller turns on the temperature sensing circuit periodically and the device alternates from a temperature sensing mode and a resting mode. When the temperature of the resistive heating element is lower than the target temperature, the controller turns on the heating circuit for a predetermined period of time, and the device is in a heating mode for a predetermined period to heat the resistive heating element. In some embodiments, the controller is in the form of CPU, MCU, CPLD, FPGA, or a digital logic circuit composed of separate elements.

The temperature sensing circuit is configured to sense the temperature of the resistive heating element. In some embodiments, the temperature sensing circuit comprises a first electric switch and a precision constant current source. At temperature sensing mode, the controller turns on the first electric switch, and allows electrical current from the constant current source to pass through the resistive heating element.

Suitable working frequencies of the first electric switch are frequencies that are compatible with a high speed temperature control. Specific working frequencies of the first electric switch depend on the electric capacity and electric power of the part to be heated. Exemplary working frequencies of the first electric switch include, about 10 Hz to about 1000 Hz, including for example about 20 Hz to about 500 Hz, about 50 Hz to about 200 Hz, about 100 Hz.

The current of the precision constant current source is insufficient to significantly increase the temperature of the resistive heating element. Temperature increase arising from the current from the precision constant current source can thus be ignored. The precision of the precision constant current source depends on the precision requirement of the temperature control device. Typically, the precision of the precision constant current source is less than about 1/100, including for example less than about any of 1/200, 1/300, 1/400, 1/500, 1/600, 1/700, 1/800, 1/900, 1/1000, 1/2000, or 1/3000. For example, when the target temperature is from about room temperature to about 100° C., and the precision requirement for the temperature control is about ±0.3° C., the precision of the precision constant current source would be about 1/1000.

Because the resistance of the heating element changes with temperature monotonically, the temperature of the resistive heating element directly correlates with the resistance of the resistive heating element. Further, because the potential difference between any two points on the resistive heating element is the product of the resistance and the current between the two points, and the current of the resistive heating element is constant, the difference in potential between the two points correlates directly with the resistance, and thus temperature, of the resistive heating element. By measuring the difference in potential of the two points on the resistive heating element, the temperature of the resistive heating element can be accurately ascertained.

The temperature sensing circuit of the device can further comprise a voltage differential amplifier connected to the resistive heating element, which amplifies the difference in potential between the two points on the resistive heating element that connect to the temperature sensing circuit. Preferably, the voltage differential amplifier measures the voltage signal without affecting the electric current of the resistive heating element, that is, the current passing the noninverting and inverting inputs of the voltage differential amplifier is significantly lower than (such as lower than about 1/100, 1/200, 1/500, or 1/1000 of) the electric current of the precision constant current source.

The temperature sensing circuit may further comprise an analog/digital converter. The input end of the analog/digital converter is connected to the output end of the voltage differential amplifier, and the output end of the analog/digital converter is connected to the input end of the controller. The analog/digital converter converts the analog signal obtained from the voltage differential amplifier into digital signals, and feeds the digital information to the controller.

The heating circuit is configured to heat the resistive heating element. In some embodiments, the heating circuit comprises a second electric switch and a constant voltage source. At the heating mode, the controller turns on the second electric switch, and allows electric current from the constant voltage source to pass through the resistive heating element, thereby heats the resistive heating element.

Suitable working frequencies of the second electric switch are frequencies that are compatible with a high speed temperature control. Specific working frequencies of the second electric switch depend on the electric capacity and electric power of the part to be heated. Exemplary working frequencies of the second electric switch include, about 10 Hz to about 1000 Hz, including for example about 20 Hz to about 500 Hz, about 50 Hz to about 200 Hz, about 100 Hz. In some embodiments, the working frequency of the second electric switch is the same as that of the first electric switch. In some embodiments, the working frequency of the second electric switch is different from that of the first electric switch.

The power of the constant voltage source depends on the heat capacity of the parts to be heated and the desired heating rate. Typically, the power of the constant voltage source is sufficient to heat the resistive heating element.

In some embodiments, the device was a four-wire measurement method for temperature sensing and control. In the four-wire measurement configuration, the resistive heating element is connected with four wires arranged sequentially. The two distal wires are connected to the heating circuit, while the two middle wires are connected to the temperature sensing circuit. The connection points of the two middle wires on the resistive heating element are substantially far from each other, that is, the distance between the two connection points is sufficient to allow detectable difference in potential be measured. Typically, the further the two points are, the bigger the difference in potential. Thus the two points are preferably positioned as far away from each other as possible, provided that they are between the connections points for the two distal wires connecting to the heating circuit. The resistance between the two middle points reflects the temperature of the resistive heating element. Because the electric current between the two middle points on the resistive heating element is very small, the difference in potential between the two middle points directly reflects the temperature of the resistive heating element. This ensures accuracy and reproducibility of temperature measurement.

In some embodiments, there is provided a temperature control device comprising: a) a resistive heating element, wherein the resistance of the resistive heating element monotonically changes with its temperature, b) a temperature sensing circuit configured to determine the temperature of the resistive heating element, comprising a first electric switch, a precision constant current source, a voltage differential amplifier, and an analog/digital converter, c) a heating circuit configured to heat the resistive heating element, comprising a second electric switch and a constant voltage source, and d) a controller configured to control the activation of the temperature sensing circuit and the heating circuit, wherein the output end of the amplifier is connected to the input end of the analog/digital converter, and wherein the output end of the analog/digital converter is connected to the input end of the controller. In some embodiments, the resistive heating element is connected with four wires arranged sequentially, wherein the two distal wires are connected to the heating circuit, wherein the two middle wires are connected to the temperature sensing circuit, and wherein the connection points of the two middle wires on the resistive heating element are substantially far from each other.

Also provided herein are methods of controlling temperature of a resistive heating element wherein the resistance of the resistive heating element monotonically changes with its temperature, comprising: a) sensing an initial temperature of the resistive heating element, b) passing electric current through the resistive heating element for a predetermined heating period to increase the temperature of the resistive heating element when the initial temperature of the heating element is below a predetermined target temperature, and c) repeating steps a) and b). In some embodiments, steps a) and b) are regulated by a controller, such as a controller described herein.

The heating period depends on the minimum heating capacity of the part to be heated and the desired maximum temperature fluctuation of the device. In some embodiments, the predetermined heating period is less than about any of 100 milliseconds, including for example less than about 50, 10, 5, or 1 millisecond.

In some embodiments, steps a) and b) in methods described herein are repeated regularly. The frequencies of the two steps depend on the heat capacity of the part to be heated. For example, when the element to be heated is small, and the temperature easily fluctuates, a high frequency is desired. Suitable frequencies include, for example, about 10 Hz to about 1000 Hz, about 20 Hz to about 500 Hz, about 50 Hz to about 200 Hz, about 100 Hz. In some embodiments, the steps a) and b) are repeated more frequently than every second, every 100 millisecond, every 50 millisecond, or every 10 millisecond.

In some embodiments, the step of sensing of the initial temperature of the resistive heating element is achieved by determining the resistance of the resistive heating element, such as by using the four-terminal measurement method described herein. In some embodiments, the method is carried out by using the temperature control device described herein.

The methods and devices described herein are useful for controlling temperature of a variety of materials. The methods and devices are particularly suitable for controlling temperature of the interior of a container (such as a biological sample or solution in a container) that cannot be accessed by a traditional temperature sensor. In some embodiments, the methods and devices are useful for measuring the temperature of a capillary tube (or a biological sample or solution contained within the capillary tube). For example, the resistive heating element may comprise wires winding around the capillary tube.

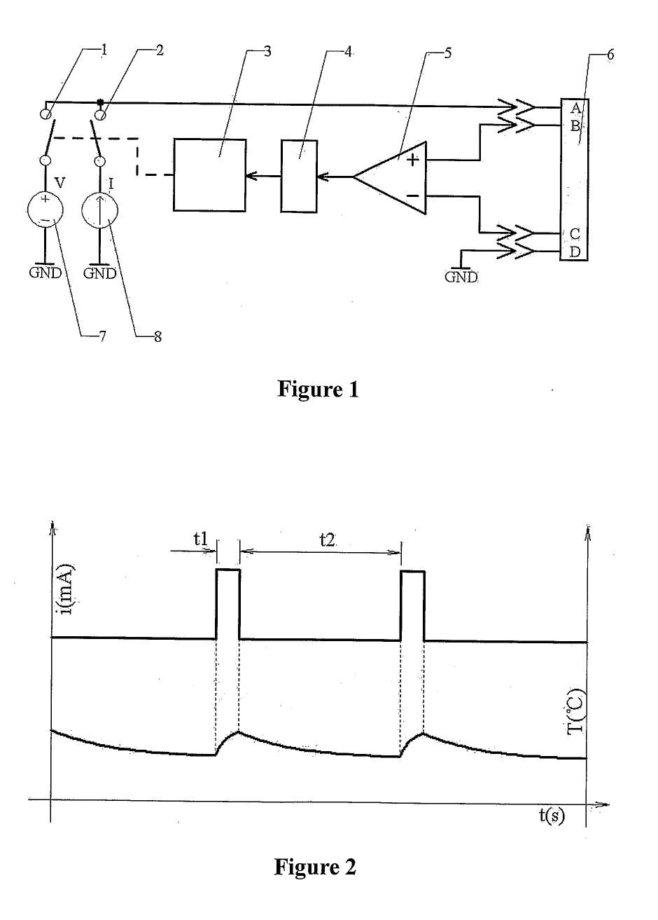

FIG. 1 shows the configuration of an exemplary temperature control device. Controller (3) compares the initial temperature of resistive heating element (6) with a target temperature, decides the action of second electric switch (1) and first electric switch (2), thereby maintain the temperature of resistive heating element (6) at or around the target temperate within certain precision. Constant voltage source (7) provides heating energy to heating element (6), and precision constant current source provides fine current for detection. Points A and D are on resistive heating element (6) with an effective distance between them being the farthest. Point B, which is located between point A and point D, is as close to point A as possible. Point C, which is located between point A and point D, is as close to point D as possible. The signal to be detected between points B and C is maximal. The voltage signals at point B and C are subtracted by voltage dependent amplifier (5), and the result is sent to analog/digital converter (4). Analog/digital converter (4) converts the signal into digital signal and sends the signal to controller (3) for further processing.

During the temperature control process, the temperature control device is generally alternating between a resting mode and a temperature sensing mode. The second electric switch (1) is off, and the first electric switch (2) is periodically turned on. Electric current from the constant voltage source enters the resistive heating element from point A, goes off from point D on the resistive heating element, and enters the ground end. The electric current results in a drop in potential on the resistive heating element (6), which is reflected by the difference in potential between points B and C. The difference in potential is the product of the electric current of the precision constant current source and the resistance between two points B and C. Because the resistance of the resistive heating element monotonically changes with its temperature, the amplified difference in potential between points B and C at the output of voltage dependent amplifier (5) directly reflects the actual temperature of resistive heating element (6). If the temperature of the resistive heating element is greater than or equal to the target temperature, the temperature control device will alternate between a temperature sensing mode and a resting mode, allowing the resistive heating element to cool down.

When the temperature of the resistive heating element drops below the target temperature, the controller will set the temperature control device to a heating mode by activating the heating circuit. First switch (2) is turned off, and second switch (1) is turned on. A heating current, which is much larger than the current from the precision constant current source, flows into the resistive heating element (6), heating the element up rapidly. This heating mode is maintained for a predetermined period, then the heating circuit is turned off and the resistive heating element is allowed to cool down.

The temperature control device thus switches between the temperature sensing mode and the heating mode constantly, keeping the actual temperature of resistive heating element (6) at a permissible precision range.

FIG. 2 provides the electric current curve and the temperature curve for the temperature control device. The curve on the upper side represents the current on the resistive heating element. The curve on the lower side represents the actual temperature of the resistive heating element. In the t1 cycle, the device is operating at the heating mode, with a larger current loading on the resistive heating element. The temperature rapidly increases during the t1 cycle. At t2 cycle, the device is periodically set to a temperature sensing mode. A small electric current from the precision constant current source flows into the resistive heating element. The effect of the electric current on the temperature of the resistive heating element is very small, and the resistive heating element cools down naturally. Once the actual temperature is lower than the target temperature, the device will switch to a heating mode and heat the resistive heating element again.

The example provided below further illustrates the present invention.

### EXAMPLE

This example shows use of the inventive device to heat a capillary tube. The capillary tube had an inner diameter of 0.5 mm, an outer diameter of 1 mm, and a length of 15 mm. A 9Ω resistive heating element in the form of wires wound around the capillary tube. Temperature of the capillary tube was determined based on the temperature of the resistive heating element, whose resistance monotonically changed with its temperature. The electric current for temperature sensing was 5.00 mA. The heating voltage was 12VDC. The predetermined heating period was 1.0 ms. The rate of the temperature increase was 15° C./s. The precision was ±0.1° C.

Although the foregoing invention has been described in some detail by way of illustration and example for purposes of clarity of understanding, it is apparent to those skilled in the art that certain minor changes and modifications will be practiced. Therefore, the description and examples should not be construed as limiting the scope of the invention.

1. A temperature control device comprising a resistive heating element, a temperature sensing circuit, a heating circuit, and a controller,
wherein the resistance of the resistive heating element monotonically changes with its temperature,
wherein the temperature sensing circuit is configured to determine the temperature of the resistive heating element,
wherein the heating circuit is configured to heat the resistive heating element, and
wherein the controller is configured to control the activation of the temperature sensing circuit and the heating circuit.

2. The temperature control device of claim 1, wherein the temperature sensing circuit comprises a first electric switch and a precision constant current source.

3. The temperature control device of claim 2, wherein the working frequency of the first electric switch is compatible with high speed temperature control cycles.

4. The temperature control device of claim 1, wherein the precision of the precision constant current source meets the precision requirement for the temperature control.

5. The temperature control device of claim 1, wherein the heating circuit comprises a second electric switch and a constant voltage source.

6. The device of claim 5, wherein the working frequency of the second electric switch is compatible with high speed temperature control cycles.

7. The temperature control device of claim 5, wherein the current of the constant voltage source is sufficient to heat the resistive heating element.

8. The temperature control device of claim 1, wherein the temperature sensing circuit comprises a voltage differential amplifier connected to the resistive heating element.

9. The temperature control device of claim 8, wherein the inputs of the non-inverting and inverting phases of the voltage differential amplifier do not significantly affect the electric current of the resistive heating element.

10. The temperature control device of claim 8, wherein the temperature sensing circuit comprises an analog/digital converter, wherein the input end of the analog/digital converter is connected to the output end of the voltage differential amplifier, and wherein the output end of the analog/digital converter is connected to the input end of the controller.

11. The temperature control device of claim 1, wherein the controller is in the form of CPU, MCU, CPLD, FPGA, or a digital logic circuit composed of separate elements.

12. The temperature control device of claim 1, wherein the resistive heating element is connected with four wires arranged sequentially,
wherein the two distal wires are connected to the heating circuit,
wherein the two middle wires are connected to the temperature sensing circuit, and
wherein the connection points of the two middle wires on the resistive heating element are substantially far from each other.

13. The temperature control device of claim 1, wherein the temperature control device does not comprise a separate temperature sensor.

14. A temperature control device comprising:
a) a resistive heating element, wherein the resistance of the resistive heating element monotonically changes with its temperature,
b) a temperature sensing circuit configured to determine the temperature of the resistive heating element, comprising a first electric switch, a precision constant current source, a voltage differential amplifier, and an analog/digital converter,
c) a heating circuit configured to heat the resistive heating element, comprising a second electric switch and a constant voltage source, and
d) a controller configured to control the activation of the temperature sensing circuit and the heating circuit,
wherein the output end of the amplifier is connected to the input end of the analog/digital converter,
wherein the output end of the analog/digital converter is connected to the input end of the controller.

15. The temperature control device of claim 13, wherein the resistive heating element is connected with four wires arranged sequentially,
wherein the two distal wires are connected to the heating circuit,
wherein the two middle wires are connected to the temperature sensing circuit, and
wherein the connection points of the two middle wires on the resistive heating element are substantially far from each other.

16. A method of controlling temperature of a resistive heating element wherein the resistance of the resistive heating element monotonically changes with its temperature, comprising:
a) sensing an initial temperature of the resistive heating element,
b) passing electric current through the resistive heating element for a predetermined heating period to increase the temperature of the resistive heating element when the initial temperature of the heating element is below a predetermined target temperature,
c) repeating steps a) and b).

17. The method of claim 16, wherein steps a) and b) are regulated by a controller.

18. The method of claim 16, wherein the predetermined heating period is less than about 10 milliseconds.

19. The method of claim 16, wherein steps a) and b) are repeated regularly.

20. The method of claim 19, wherein steps a) and b) are repeated more frequently than every second.

21. The method of claim 16, wherein the sensing of the temperature of the resistive heating element is achieved by determining the resistance of the resistive heating element.

22. The method of claim 21, wherein the resistance of the resistive heating element is determined by four-terminal method.

23. Use of the temperature control device of claim 1 for control temperature of a container.

24. The use of claim 23, wherein the interior of the container cannot be accessed by a traditional temperature sensor.

25. The use of claim 23, wherein the container is a capillary tube.

26. The use of claim 23, wherein the resistive heating element comprises wires winding around the capillary tube.
